(19) United States
(12) Patent Application Publication
(10) Pub. No.: US 2008/0266894 A1
(43) Pub. Date: Oct. 30, 2008

(54) Imaging device illumination system

(76) Inventor: Hosein Ali Razavi, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/789,722

(22) Filed: Apr. 24, 2007

(51) Int. Cl. F21V 7/04; G02B 5/02

(52) U.S. Cl. 362/558

(57) ABSTRACT

An imaging device illumination system comprises an elongate light pipe configured to receive light from a light source and propagate the light therethrough, and a diffusive reflector disposed about at least a portion of the light pipe and configured to direct light from the light pipe toward an object to be imaged.

### BACKGROUND

Light emitting diode (LED) light sources are often used in imaging devices to illuminate an object to be imaged instead of a cold cathode fluorescent light (CCFL) or other type of light source because of light output stability over time, reduced size, lower power consumption and less thermal output. In some imaging devices, the LED light source serves as a point source that is converted to a line source in combination with a light pipe where light from the LED light source enters one end of the light pipe and is emitted by the light pipe over a length thereof toward a scan line of the object. A reflector is sometimes disposed around the light pipe and having an opening therein in order to direct the light emitted by the light pipe in a particular direction (e.g., toward the object to be imaged). However, such light source assemblies are subject to losses as the light propagates along or through the light pipe (e.g., because of inherent reflectivity and/or light propagation characteristics associated with the light pipe and/or reflector, because of energy losses through or absorbed by the reflector, etc.). Thus, the intensity and/or uniformity of light emitted by the light assembly varies over a length of the light assembly, thereby resulting in a dim linear light source, poor signal-to-noise ratio, and a non-uniform illumination profile each of which adversely impacts image quality.

### BRIEF DESCRIPTION OF THE DRAWINGS

FIG. 1 is a diagram illustrating a scanner device in which an embodiment of an imaging device illumination system is used to advantage;

FIG. 2 is a diagram illustrating an embodiment of a light guide assembly of the imaging device illumination system of FIG. 1;

FIGS. 3A and 3B are diagrams illustrating a partial section view of the light guide assembly of FIG. 2 taken along the line 3-3 of FIG. 2; and

FIG. 4 is a diagram illustrating a view of an internal surface of a reflector of the light guide assembly of FIGS. 2 and 3A/3B.

### DETAILED DESCRIPTION OF THE DRAWINGS

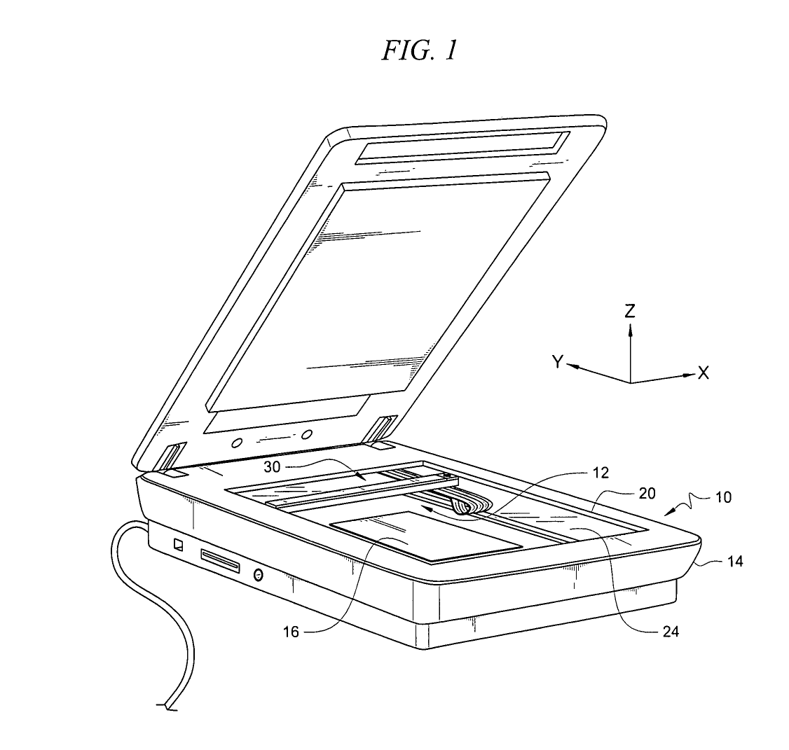

FIG. 1 is a diagram illustrating an imaging device 10 in which an embodiment of an illumination system 12 is employed to advantage. In the embodiment illustrated in FIG. 1, imaging device 10 comprises a flatbed scanner 14. However, it should be understood that imaging device 10 may comprise any type of device for capturing and/or otherwise generating an image of an object (e.g., a document 16) such as, but not limited to, a copier, printer, facsimile device and multi-function device. Further, it should be understood that imaging device 10 may be configured for reflective scanning and/or transmissive scanning.

In FIG. 1, imaging device 10 comprises a platen 20 defining an imaging area 24 for receiving an object to be imaged. In the embodiment illustrated in FIG. 1, system 12 comprises a light guide assembly 30 extending across imaging area 24 in at least one direction. For example, in some embodiments, light guide assembly 30 is configured to move relative to platen 20 in a direction corresponding to the Y axis indicated in FIG. 1, thereby facilitating generation of a scanned image of document 16 while light guide assembly 30 illuminates document 16 while moving in the Y-axis direction. Thus, in the embodiment illustrated in FIG. 1, light guide assembly 30 extends transversely across platen 20 relative to a scanning direction (i.e., a direction corresponding to the Y axis). Additionally or alternatively, imaging device 10 may be configured such that light guide assembly 30 remains stationery while an object to be imaged is moved past light guide assembly 30 (e.g., such as an in automatic document feed application). Thus, in this embodiment, for example, document 16 may be fed past light guide assembly 30 and illuminated while light guide assembly 30 remains stationary.

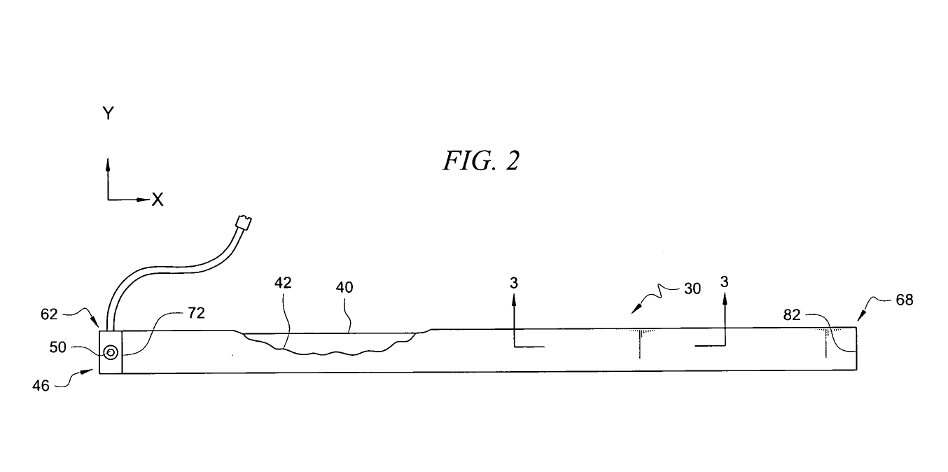

FIG. 2 is a diagram illustrating an embodiment of light guide assembly 30. In the embodiment illustrated in FIG. 2, light guide assembly 30 comprises an elongate, linear light pipe 40 and a reflector 42 extending across imaging area 24 in a direction corresponding to the X axis. In FIG. 2, light guide assembly 30 is aligned in the direction corresponding to the X axis. However, it should be understood that light guide assembly 30 may be otherwise positioned and/or oriented within imaging device 10. Light pipe 40 may be formed from acrylic, polycarbonate or generally any optically clear, moldable resin. However, it should be understood that other materials may be used to form light pipe 40. Light pipe 40 may be configured having an elliptical shape, cylindrical shape, rectangular shape, or other geometric configuration of constant or non-constant cross-section. Reflector 42 is disposed around and/or covers at least a portion of light pipe 40 and has an opening and/or slit formed therein extending linearly along light guide assembly 30 for enabling light in light pipe 40 to exit therefrom and direct the light emitted by light pipe 40 onto a scan line of an object to be imaged (e.g., a slit or opening in the reflector 42 extending longitudinally along a linear length of light pipe 40).

Light guide assembly 30 also comprises a light source 46 disposed at or near an end of light guide assembly 30. However, it should be understood that two light sources may be used (e.g., one mounted at each end of light guide assembly 30). In some embodiments, light source 46 comprise a light emitting diode (LED) 50. LED 50 may comprise a single LED, a tri-color LED or an LED array (e.g., green, blue and red LEDs). Light pipe 40 comprises a proximal end 62 disposed near LED 50 and a distal end 68. Proximal end 62 comprise an input window 72 for receiving light emitted by LED 50. Distal end 68 comprises an end face 82 which may be reflective or non-reflective. In some embodiments, distal end 68 may also comprise an input window for receiving light by another LED package that may be similar to or different from LED 50. In operation, LED 50 emits rays of light into light pipe 40 via an input window 72 which propagates down and/or through light pipe 40 and is reflected outwardly at a desired location of light pipe 40 by reflector 42 in a direction corresponding to a location of an object to be imaged. Thus, light pipe 40 and reflector 42 are configured to direct light onto a scan line of document 16 which is then captured by an optical assembly (e.g., an optical lens array and/or photosensitive element) that converts the detected light into an electrical signal indicative of a scanned image of document 16.

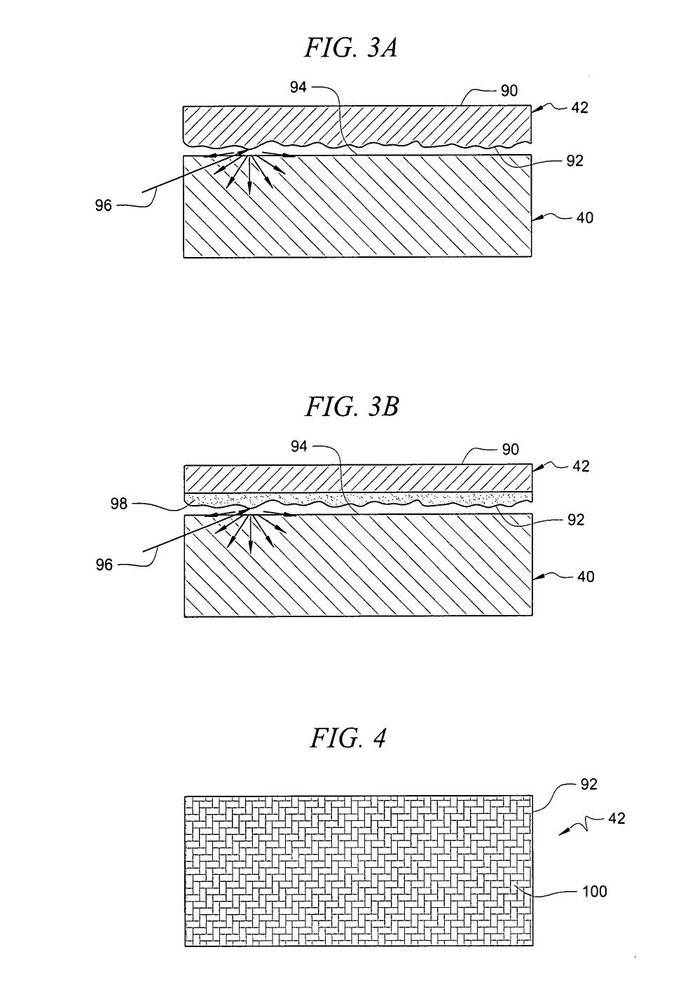

FIGS. 3A and 3B are diagrams illustrating a partial section view of light guide assembly 30 taken along the line 3-3 of FIG. 2. In the embodiment illustrated in FIGS. 3A and 3B, reflector 30 comprises an exterior surface 90 and an interior surface 92 such that interior surface 92 is directed toward and/or otherwise faces an exterior surface 94 of light pipe 40. In FIGS. 3A and 3B, reflector 42 and light pipe 40 are shown having a slight gap therebetween. This slight gap is for illustrative purposes as it should be understood that, in some embodiments, at least a portion of surface 92 of reflector 42 may be in direct contact with surface 94 of light pipe 40.

In the embodiment illustrated in FIGS. 3A and 3B, reflector 40 is configured as a diffusive reflector 42 such that surface 92 of reflector 42 comprises a non-smooth, uneven and/or roughened surface to produce a diffusive reflection of light impinging thereon. For example, specular reflectors comprise a substantially planar surface characterized by an angle of incidence of light being substantially equal to an angle of reflection of the light, whereas diffusive reflectors are characterized by reflecting and scattering incident light. In the embodiment illustrated in FIGS. 3A and 3B, surface 92 is configured as an irregularly textured surface 92 to produce greater diffusive reflection than specular reflection. For example, in the embodiment illustrated in FIGS. 3A and 3B, light, indicated by arrow 96 in FIGS. 3A and 3B, received from light source 46 (FIG. 2) into light pipe 40 that strikes surface 92 is reflected at a number of different angles. In FIG. 3A, the irregularly and/or roughened texture of surface 92 is integrally formed in reflector 42 (i.e., formed as a single, unitary structure). In FIG. 3B, a coating 98 is disposed on and/or otherwise applied to reflector 42 to form the irregularly and/or roughened texture of surface 92. Coating 98 may comprise any type of reflective coating applied in a manner that results in an irregular and/or rough texture or that, after application, is modified to produce an irregular and/or rough texture.

FIG. 4 is a diagram illustrating a plan view of surface 92 of reflector 42. In the embodiment illustrated in FIG. 4, surface 92 comprises a light-diffusing, three-dimensional, variable depth pattern 100. Pattern 100 may comprise a polygonally-shaped, irregularly-shaped, or other type of repeating or non-repeating pattern extending longitudinally along reflector 42. In some embodiments, pattern 100 may remain uniformly distributed along reflector 42 from proximal end 62 to distal end 68 of light guide assembly 30 (FIG. 2). However, it should be understood that pattern 100 may also be non-uniformly distributed along a length of reflector 42 (e.g., changing in pattern geometry and/or pattern depth).

Thus, embodiments of system 12 provide a diffusive reflector 42 that substantially reduces light losses of light guide assembly 30. For example, surface 92 of reflector 42 substantially reduces an amount of light that may be otherwise absorbed and/or transmitted through reflector 42. Thus, surface 92 produces diffusive reflectivity of light impinging thereagainst, thereby reducing light losses and enabling a brighter light source with a more uniform distribution of light along and/or emitted from light guide assembly 30.

What is claimed is:

1. An imaging device illumination system, comprising:
an elongate light pipe configured to receive light from at least one light source and propagate the light therethrough; and
a diffusive reflector disposed about at least a portion of the light pipe and configured to direct light from the light pipe toward an object to be imaged.

2. The system of claim 1, wherein the diffusive reflector comprises a non-smooth surface facing the light pipe.

3. The system of claim 1, wherein the diffusive reflector comprises an irregularly textured surface disposed toward the light pipe.

4. The system of claim 1, wherein the diffusive reflector comprises a diffusive coating applied to a surface of the reflector facing the light pipe.

5. The system of claim 1, wherein the diffusive reflector comprises a roughened surface integrally formed on the reflector facing toward the light pipe.

6. The system of claim 1, wherein the diffusive reflector comprises a light-diffusing pattern disposed on a surface of the reflector facing toward the light pipe.

7. The system of claim 1, wherein the diffusive reflector comprises a light-diffusing pattern uniformly distributed along a surface of the reflector facing the light pipe.

8. An imaging device, comprising:
a light pipe; and
a reflector disposed about at least a portion of the light pipe and configured to direct light from the light pipe toward an object to be imaged, the reflector having a roughened, light-diffusing textured surface facing the light pipe.

9. The imaging device of claim 8, wherein the textured surface is integrally formed on the reflector.

10. The imaging device of claim 8, wherein the textured surface comprises a coating applied to the reflector.

11. The imaging device of claim 8, wherein the textured surface comprises a light-diffusing pattern disposed facing the light pipe.

12. The imaging device of claim 8, wherein the textured surface comprises a light-diffusing pattern uniformly distributed along the surface of the reflector facing the light pipe.

13. An imaging device, comprising:
means for inputting light into a light propagation means; and
means for reflecting the light from the light propagation means toward an object to be imaged, the reflecting means disposed about at least a portion of the light propagation means and having a roughened, light-diffusing textured surface facing the light propagation means.

14. The imaging device of claim 13, wherein the textured surface is integrally formed on the reflecting means.

15. The imaging device of claim 13, wherein the textured surface comprises a coating applied to the reflecting means.

16. The imaging device of claim 13, wherein the textured surface comprises a light-diffusing pattern facing the light propagation means.

17. The imaging device of claim 13, wherein the textured surface comprises a light-diffusing pattern uniformly distributed along the surface of the reflecting means facing the light propagation means.
